(19) United States
(12) Patent Application Publication
(10) Pub. No.: US 2004/0189605 A1
(43) Pub. Date: Sep. 30, 2004

(54) Mouse with multi-axis inputting device

(76) Inventor: Ken Shih, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/698,460

(22) Filed: Nov. 3, 2003

(30) Foreign Application Priority Data
Mar. 25, 2003 (TW) 092106685

(51) Int. Cl. G09G 5/08

(52) U.S. Cl. 345/163

(57) ABSTRACT

A mouse with a multi-axis inputting device is provided. The device comprises a cover and a base, wherein except for at least one first groove provided at the top-surface of the cover, at least one-second groove is provided at the side-surface of a housing of the mouse. Moreover, a first scroll controller and a second scroll controller may be similarly fixed on an interface circuit board, which is further located on the base. A part of volume of a first wheel of the first scroll controller may be exposed at the top-surface of the housing of the mouse through the first groove for controlling the vertical scroll or third axis on the computer window, while a part of volume of a second wheel of the second scroll controller may be exposed at the side-surface of the housing of the mouse through the second groove for controlling the horizontal scroll or fourth axis on the computer window. Therefore, the convenient manipulation and selection for the position on the window frame may be provided for the user.

### FIELD OF THE INVENTION

The present invention is related to a mouse, particularly to a mouse with a multi-axis inputting device, being convenient for the user to manipulate and select the position on the window frame.

### BACKGROUND

Accordingly, a computer mouse has been chosen as a best tool for commanding information products by users for a long time, owing to inherent advantages of easy manipulation, low cost, and powerful function.

A conventional structure of mouse essentially comprises a ball provided in a base. The position where the cursor is needed to be located or the order to be commanded may be transmitted via the ball, manipulated by the user to displace on the desk-top or mouse pad.

In the developing information industry, except for the two-dimension application, the vertical scroll, the horizontal scroll, the third or the fourth axis provided for spatial application may be used in the current computer window application, such that the requirement for whole facility and humanization could not be achieved obviously by the above conventional structure of first-grade mouse, although the facility and practicability may be indeed inherent in it. Thus, the industry has made an effort to develop a structure of second-generation mouse, disclosed in U.S. Pat. No. 6,522,321, entitled “Roller Retainer For A Third Axis Of A Mouse”; U.S. Pat. No. 6,340,966, entitled “Clamping Device For Third-Axis Input Device Of Mouse”; TAIWAN Patent Publication No. 297518, entitled “Third-Axis Inputting Device For Mouse”; TAIWAN Patent Publication No. 378772, entitled “Improved Construction For Third-Axis Inputting Device In Mouse”; TAIWAN Patent Publication No. 478622, entitled “Fixed Construction Of Third-Axis Roller For Mouse”; and CHINA Patent Publication No. 2269605, entitled “Third-Axis Inputting Device For Mouse”, as examples. The conventional structure of second-generation mouse is technologically disclosed in the above-mentioned disclosures in detail.

Referring to FIG. 1, there is shown an exploded perspective view of a conventional structure of second-generation mouse. The conventional structure of second-generation mouse 10 is essentially assembled with a cover 11 and a base 13, wherein a first function key (left key) 113 and a second function key (right key) 115 may be provided at the top-surface of the cover 11, and a groove 117 may be provided between the first function key 113 and the second function key 115. Moreover, an interface circuit board 15 may be fixed on the base 13, united with the cover 11 to form a housing 10 of the mouse. At least a cursor inputting device 19, such as the ball shown herein, is provided on the interface circuit board 15. For the coordination with the position of the left key 113, the right key 115, and the groove 117, a first button switch 153, a second button switch 155, and a set of scroll controller 17 may be provided at the other side of the interface circuit board 15 for cooperating correspondingly therewith, wherein the scroll controller 17 comprises a bracket 131 fixed on the base, a wheel 171, a part of volume of which may project outside the groove 117 as the cover 11 and the base 13 are united, a transmission shaft 177 connected to the wheel 171, a sensitized rotary-disk 173 and a light-sensing module 175 (for example, infrared transmitting/receiving means) situated at the side of the wheel 171, and a third button switch 179 depressed by the suppression of the transmission shaft 177 as an external force is applied to the wheel 171. The delivery of the data command may be accomplished by a wired data transmission line 135 or a wireless transmission unit 137 (for instance, an infrared transmission unit).

When the cursor on the window frame is intended to be displaced toward the prescribed position by the user, the displacement of the ball 19 could be used to achieve this object. Further, as certain functions are intended to be executed, the depression operation of the left key 113 or right key 115 could be served for controlling the first button switch 153 or second button switch 155 to transmit a specific command intended to be accomplished. Furthermore, when it is intended to execute the displacement of the third axis or vertical scroll on the computer window frame by the user, the rotation of the wheel 171 operated by the external force is required, and then the sensitized rotary-disk 173, the light-sensing module 175, the transmission shaft 177, and the third button switch 179 may be driven for commanding the order intended to be executed.

The object of the control for the cursor, the third axis or vertical scroll on the computer window to displace could be readily achieved by the above conventional structure of second-generation mouse. However, except for the third axis or vertical scroll, sometimes, there is still a fourth axis or horizontal scroll designed to be positioned on the computer window, such that the object of ready manipulation for the fourth axis or horizontal scroll could not be achieved by the structure of second-generation mouse obviously. For this purpose, a structure of third-generation mouse has been further developed, disclosed in TAIWAN Patent Publication No. 330710, entitled “Multi-Axis Inputting Device For Mouse”; and TAIWAN Patent Publication No. 438013, entitled “Multi-Axis Signal Device For Mouse With Infrared Transmission”, as examples. The conventional structures of third grade mouse are technologically disclosed in the above-mentioned disclosures in detail.

Referring to FIG. 2, there is shown a schematic perspective view of a structure of third-generation mouse. The conventional structure of third-generation mouse 20 is essentially assembled with a cover 21 and a base 23, and a first function key (left key) 213 and a second function key (right key) 215 may be equally provided at the top-surface of the cover 21, but a first groove 217 and second groove 219 are further provided between the left key 213 and the right key 215, wherein a first wheel 271 of a first controller is received in the first groove 217, and a second wheel 291 of a second scroll controller is correspondingly received in the second groove 219. The operation of the third axis or vertical scroll on the computer window may be controlled by the rotation of the first wheel 271, ant that of the fourth axis or horizontal scroll may be controlled by the rotation of the second wheel 291.

Consequently, the object of the manipulation for the cursor, the third axis or vertical scroll, and the fourth axis or horizontal scroll on the computer window to displace has been successfully achieved by the structure of third-generation mouse. In the conventional structure of third-generation mouse, however, the first wheel 271 and the second wheel 291 are both provided at the top-surface of the cover 21, in principle, such that in use, both of the wheels need to be manipulated by the same finger of the user simultaneously, leading to incapable of determining which one is the first wheel 271, and which one is the second wheel 291. Thus, it is quite possible to make a wrong selection when manipulating, and even stress the user. It is not only inconvenient for use, but also hard to achieve the object of entirely humanized manipulation.

### SUMMARY OF THE INVENTION

Accordingly, how to design a novel structure of mouse, not only provided for readily manipulating the function of the fourth axis or horizontal scroll by the mouse, but also suitable for the conveniently humanized manipulation, is the key point of the present invention.

The present invention provides a structure of mouse provided for improving the imperfections of the above conventional structure of mouse in use.

The present invention provides a structure of mouse not only convenient for use, but also facilitating a humanized manipulating operation.

The present invention provides a structure of mouse effectively soothe the psychological stress of the user in use by a simple structure variance.

The present invention provides a structure of mouse beneficial for installing more middle keys or other function keys, resulting in effectively expanding the function of the mouse.

Thus, the main structure of one embodiment of the present invention comprises a cover and a base, wherein at least one first groove is provided at the top-surface of the cover, and at least one second groove is provided at the side-surface of the cover; moreover, an interface circuit board is fixed on the base. At least a cursor controller, a first scroll controller, and a second scroll controller may be provided on the interface circuit board, while a part of volume of the first scroll controller and the second scroll controller may be exposed outside the housing of the mouse through the corresponding first groove and second groove, respectively, after the base and the cover are united to form the housing of the mouse.

In comparison with the conventional mouse, exact positions of the first wheel and the second wheel could be readily determined by the user, since the present invention is designed for providing the second wheel at the side-surface of the housing of the mouse, not only convenient for use, but also facilitating a humanized manipulation operation. Meanwhile, by means of the design for providing the second wheel at the side-surface of the housing of the mouse, more idle space may be acquired at the top-surface of the mouse, resulting in beneficial for installing more middle keys or other function keys, so as to effectively expand the function of the mouse.

### BRIEF DESCRIPTION OF DRAWINGS

FIG. 1 is an exploded perspective view of a conventional structure of mouse;

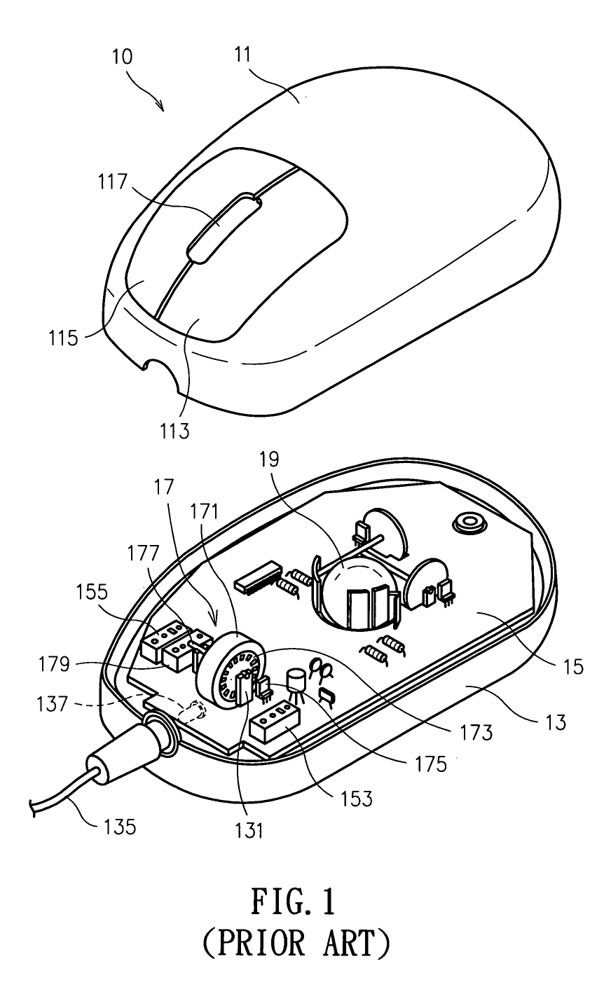

FIG. 2 is a schematic perspective view of another conventional structure of mouse;

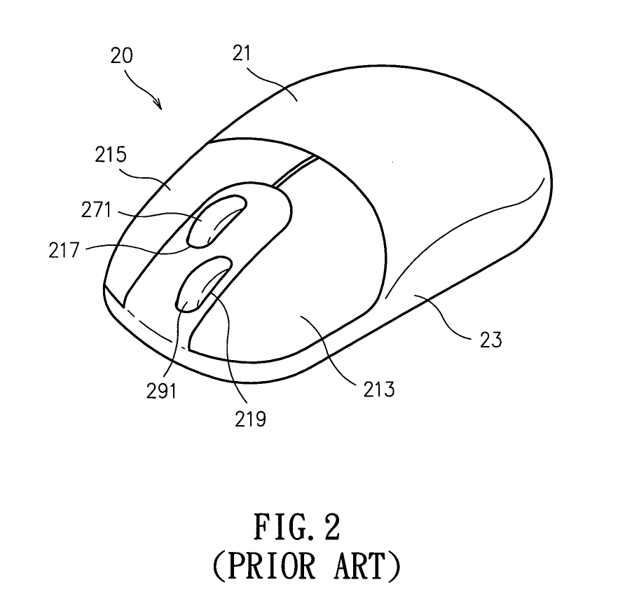

FIG. 3 is an exploded perspective view of a structure of mouse according to one embodiment of the present invention;

FIG. 4 is a schematic perspective view of the structure of mouse according to the present invention; and

FIG. 5 is a schematic perspective view of still another embodiment of the present invention.

### DETAILED DESCRIPTION

The structural features and the effects to be achieved may further be understood and appreciated by reference to the presently preferred embodiments together with the detailed description.

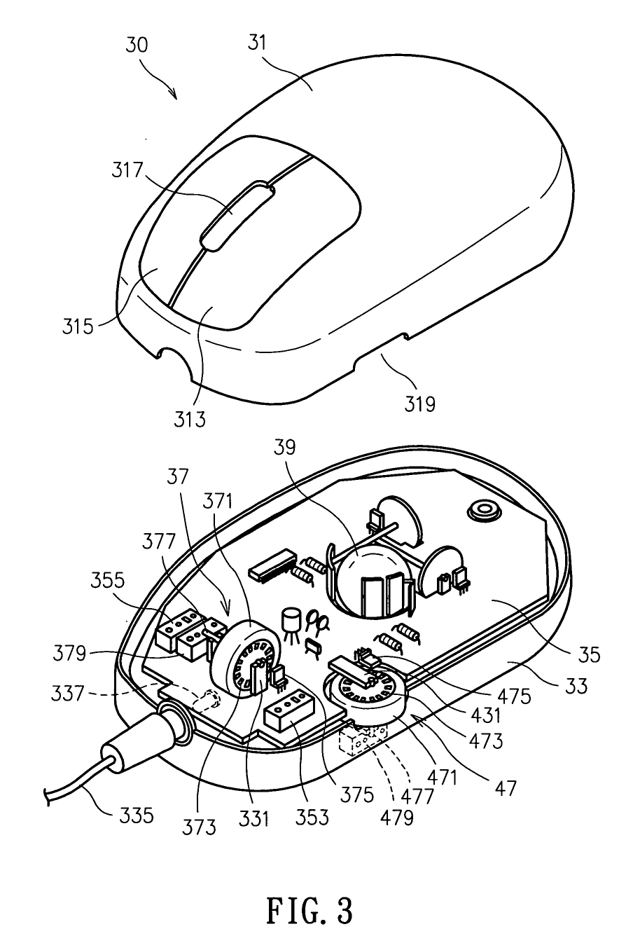

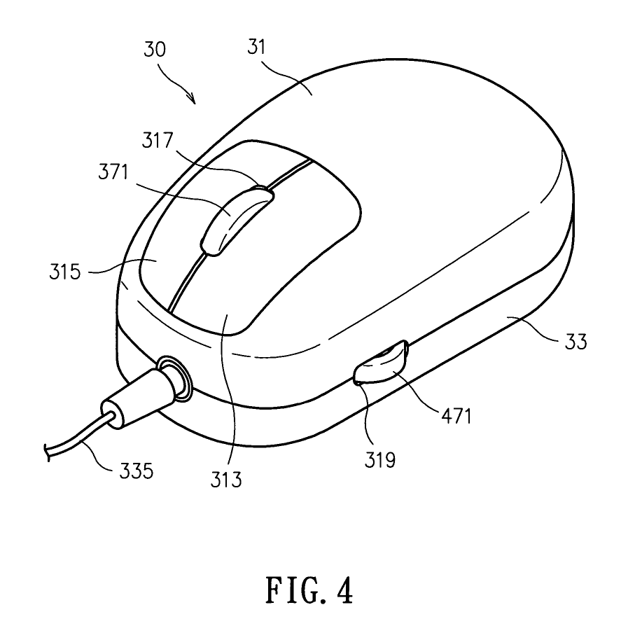

Firstly, referring to FIGS. 3 and 4, there are shown an exploded perspective view and a schematic perspective view of a structure of mouse according to one embodiment of the present invention, respectively. As shown in these figures, the mouse structure 30 of the present invention is essentially assembled with a cover 31 and a base 33, wherein at least one function key, such as a first function key (left key) 313 and a second function key (right key) 315, for example, may be provided at the top-surface of the cover 31, and a first groove 317 may be provided between the left key 313 and the right key 315, while a second groove 319 may be further provided at the side-surface of the cover 31. Moreover, an interface circuit board 35 may be fixed on the base 13, and similarly, a cursor controller 39, such as a ball illustrated in the present invention, may be fixed on the interface circuit board 35, while a first button switch 353, a second button switch 355, and a first scroll controller 37 may be provided for corresponding to the first function key 313, the second function key 315, and the first groove 317, respectively. In this case, the first button switch 353 and the second button switch 355 may be controlled by the depression operation of the first function key 313 and the second function key 315, for executing certain function commands, respectively.

Furthermore, the first scroll controller 37 comprise a first bracket 331 fixed on the base 33, a first wheel 371, a part of volume thereof projecting outside the first groove 317 when the cover 31 and the base 33 are united, a transmission shaft 377 connected to the first wheel 371, a sensitized rotary-disk 373 and a light-sensing module 375 (infrared transmitting/receiving means, as examples) situated at the side of the first wheel 371, and a third button switch 379 depressed by the suppression of the transmission shaft 377 as an external force is applied to the first wheel 371.

Furthermore, for the purpose of coordinating the location of the second groove 319 situated at the side-surface of the mouse 30, a second scroll controller 47 is then fixed at one side of the interface circuit board 35. The main structure of the second scroll controller 47 is similar to that of the first scroll controller 37, similarly having a second bracket 333 fixed on the base 33, a second wheel 471, a part of volume thereof projecting outside the second groove 417 when the cover 31 and the base 33 are united, a transmission shaft 477 connected to the second wheel 471, a sensitized rotary-disk 473 and a light-sensing module 475 (infrared transmitting/receiving means, as examples) situated at the side of the second wheel 471, and a fourth button switch 479 depressed by the suppression of the transmission shaft 477 as an external force is applied to the second wheel 471. In other words, for coordinating the lateral disposition of the second groove 319, the second scroll controller 47 may be arranged by rotating another structure of the first scroll controller 37 through an angle toward a position, such as rotating through 90 degree toward an absolute horizontal position illustrated in the present invention, as an example.

The delivery of the aforementioned data command, of course, may be accomplished by a wired data transmission line 335 or a wireless transmission unit 337 (for instance, an infrared transmission unit).

When the cursor on the window frame is intended to be displaced toward the prescribed position by the user, the displacement of the ball 39 could be used to achieve this object. Further, as certain functions are intended to be executed, the depression operation of the left key 313 or right key 315 could be served for controlling the first button switch 353 or second button switch 355 to transmit a specific command intended to be accomplished. Furthermore, when it is intended to execute the displacement of the third axis or vertical scroll on the computer window frame by the user, the rotation of the first wheel 371 operated by the external force is required, and then the sensitized rotary-disk 373, the light-sensing module 375, the transmission shaft 377, and the third button switch 379 may be driven to complete the manipulation of the position of vertical scroll, for example. Further, when it is intended to execute the displacement of the fourth axis or horizontal scroll on the computer window frame by the user, the rotation of the second wheel 471 operated by the external force is required, and then the sensitized rotary-disk 473, the light-sensing module 475, the transmission shaft 477, and the fourth button switch 479 may be driven to complete the manipulation of the position of horizontal scroll, for example.

The user may manipulate the first wheel 371 to rotate with a specific finger, such as index finger or middle finger, owing to the arrangement of the first wheel 371 on the top-surface of the housing 30 of the mouse in the present invention; while the user may manipulate the second wheel 471 to rotate with another specific finger, such as thumb, due to the arrangement of the second wheel 471 on the side-surface of the housing 30 of the mouse. The probability of temporarily making a wrong decision with respect to the locations where the first wheel 371 and the second wheel 471 reside may be substantially reduced, and thus the psychological stress of the user will be soothed as well, correspondingly, due to the fact that the first wheel 371 and the second wheel 471 are manipulated by different specific fingers. Additionally, the rotational direction of the first wheel 371 may be designed as a forward-backward together with up-down direction, in correspondence with the up-down operation of the vertical scroll on the computer window. Rather, the second wheel 471 may be designed for left-right rotation, also in correspondence with the left-right operation of the horizontal scroll on the computer window. Thus, the structure of mouse according to the present invention may truly correspond with the design concept for humanized manipulation.

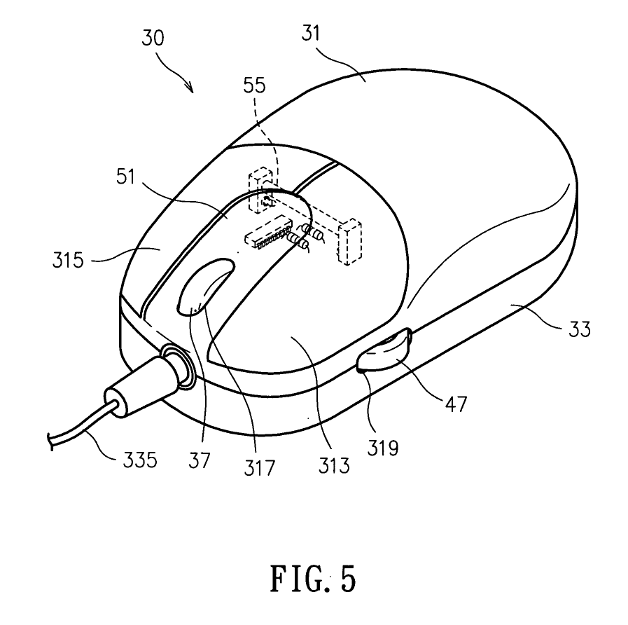

Moreover, referring to FIG. 5, there is shown a schematic perspective view of a structure of mouse according to still another embodiment of the present invention. As illustrated in this figure, there may be more idle space remained for receiving other function keys, such as a third function key (middle key) 51 may be further designed to be positioned between the left key 313 and the right key 315 for executing a certain command in this embodiment, as an example, contributed by the arrangement of the second scroll controller 47 of the present invention, transferred from the top-side of the conventional housing 30 of the mouse to the side-surface thereof. Furthermore, except for a mechanical ball, the cursor controller 395 is also applicable to a mechanical track ball or an optical light-sensing module 55, such as infrared transmitting/ receiving unit, for example.

In addition, for responding the manipulation behavior of the user or the ergonomics design, the second wheel 471 and the second groove 319 of the structure of mouse according to the present invention may designed with an absolutely horizontal mode, or an inclined mode with respect to horizontal, respectfully. Furthermore, the location of the second groove 319 may be designed to be positioned at the side-surface of the cover 31, at the side-surface of the base 33, or at the side-surface of the cover 31 in part with another part thereof at the side-surface of the base 33.

To sum up, the present invention is related to a mouse, particularly to a mouse with a multi-axis inputting device, being convenient for the user to manipulate and select the position on the window frame. Therefore, this application is filed in accordance with the patent law duly, since the present invention is truly an invention with novelty, advancement or non-obviousness, and availability by the industry, thus naturally satisfying the requirements of patentability. Your favorable consideration will be appreciated.

The foregoing description is merely one embodiment of present invention and not considered as restrictive. All equivalent variations and modifications in process, method, feature, and spirit in accordance with the appended claims may be made without in any way from the scope of the invention.

### LIST OF REFERENCE SYMBOLS

10 moue

11 cover

113 first function key

115 second function key

117 groove

13 base

131 bracket

135 data transmission line

137 wireless transmission unit

15 interface circuit board

153 first button switch

155 second button switch

17 scroll controller

171 wheel

173 sensitized rotary-disk

175 light-sensing module

177 transmission shaft

179 third button switch

19 cursor inputting device

20 mouse

21 cover

213 first function key

215 second function key

217 first groove

219 second groove

23 base

271 first wheel

291 second wheel

30 mouse

31 cover

313 first function key

315 second function key

317 first groove

319 second groove

33 base

331 first bracket

333 second bracket

335 data transmission line

337 wireless transmission unit

35 interface circuit board

353 first button switch

355 second button switch

37 first scroll controller

371 first wheel

373 sensitized rotary-disk

375 light-sensing module

379 third button switch

39 cursor controller

395 cursor controller

47 second scroll controller

471 second wheel

473 sensitized rotary-disk

475 light-sensing module

477 transmission shaft

479 fourth button switch

51 third function key

55 light-sensing module

1. A mouse with a multi-axis inputting device, comprising:
a cover, at least one first groove being provided at the top-surface of said cover, and;
a base, an interface circuit board being fixed on said base, said interface circuit board comprising at least a cursor controller, a first scroll controller, and a second scroll controller provided thereon, further comprising a second groove provided at a side-surface of a housing of said mouse, wherein a part of volume of said first scroll controller and said second scroll controller being exposed outside said housing of said mouse through said corresponding first groove and second groove, respectively, when said base and said cover are united to form said housing of said mouse.

2. The mouse according to claim 1, wherein said second groove is at a position selected from the group consisting of side-surface of said cover, side-surface of said base, and the combination thereof.

3. The mouse according to claim 1, wherein said second groove is presented as an absolutely horizontal mode.

4. The mouse according to claim 1, wherein said second groove is presented as an inclined mode with respect to horizontal.

5. The mouse according to claim 1, wherein said first scroll controller comprises a first bracket fixed on said interface circuit board, a first wheel, a part of volume thereof projecting outside said first groove, a sensitized rotary-disk and a light-sensing module situated at the side of said first wheel, and a third button switch depressed as an external force is applied to said first wheel.

6. The mouse according to claim 1, wherein said second scroll controller comprises a second bracket fixed on said interface circuit board, a second wheel, a part of volume thereof projecting outside said second groove, a sensitized rotary-disk and a light-sensing module situated at the side of said second wheel, and a fourth button switch depressed as an external force is applied to said second wheel.

7. The mouse according to claim 1, wherein said cursor controller is selected from the group consisting of ball, track ball or optical light-sensing module, and the combination thereof.

8. The mouse according to claim 1, wherein the top-side of said cover further comprises at least one function key.

9. The mouse according to claim 1, wherein said base further comprising devices selected from the group consisting of data transmission line, wireless transmission unit, and the combination thereof.

10. The mouse according to claim 1, wherein the top-side of said cover further includes a left key and a right key.

11. The mouse according to claim 10, wherein the top-side of said cover further comprising at least one function key, said function key being positioned between said left key and said right key.
